(19) United States
(12) Patent Application Publication
(10) Pub. No.: US 2019/0248368 A1
(43) Pub. Date: Aug. 15, 2019

(54) DRIVING ASSISTANCE DEVICE

(71) Applicant: SUZUKI MOTOR CORPORATION, Hamamatsu-shi (JP)

(72) Inventor: Koji KURATA, Hamamatsu-shi (JP)

(73) Assignee: SUZUKI MOTOR CORPORATION, Hamamatsu-shi (JP)

(21) Appl. No.: 16/256,741

(22) Filed: Jan. 24, 2019

(30) Foreign Application Priority Data
Feb. 13, 2018 (JP) 2018-023060

(51) Int. Cl. B60W 30/16; B60W 10/06; B60W 30/095; G08G 1/16

(52) U.S. Cl. CPC B60W 30/16; B60W 10/06; B60W 30/0956; B60W 2550/408; G08G 1/166; B60W 2550/30; G08G 1/162

(57) ABSTRACT

There is provided a driving assistance device for assisting in driving a saddle-type vehicle. A first gate passage recognizing unit is configured to recognize that a subject vehicle which is the saddle-type vehicle equipped with the driving assistance device has passed through a gate built on a road. A lateral-vehicle recognizing unit is configured to recognize a lateral vehicle traveling side by side with the subject vehicle. An acceleration assistance unit is configured to perform assistance in accelerating the subject vehicle, if the lateral vehicle is recognized at a time when the vehicle has passed through the gate.

### CROSS-REFERENCE TO RELATED APPLICATIONS

The disclosure of Japanese Patent Application No. 2018-023060 filed on Feb. 13, 2018, including specification, drawings and claims is incorporated herein by reference in its entirety.

### TECHNICAL FIELD

The present disclosure relates to a driving assistance device for assisting in driving a saddle-type vehicle.

### BACKGROUND

In order to attain active transportation safety, driving assistance devices for assisting in driving automobiles have been developed. There are various types of driving assistance devices corresponding to various scenes and situations in which automobiles travel.

As a basic driving assistance device, there is a driving assistance device which detects other vehicles, pedestrians, and so on existing in front of a vehicle equipped with the driving assistance device, by a camera, a radar, or the like, and issues a warning to the driver of the vehicle or automatically brakes the vehicle in the case where the vehicle is in danger of colliding with another vehicle, the pedestrian, or the like. Also, there is a driving assistance device which recognizes the position of the lane of a vehicle equipped with the driving assistance device by cameras and so on, and issues a warning to the driver of the vehicle or automatically controls braking and steering of the vehicle to keep the vehicle in the lane, in the case where the vehicle is about to deviate from the lane.

Also, as a driving assistance device corresponding to a limited scene, a merging assistance device for assisting in driving a vehicle equipped with the merging assistance device when the vehicle merges from an acceleration lane into a main lane in an area where the acceleration lane and the main lane join is disclosed in the following Patent Document 1.
Patent Document 1: Japanese Patent Application Publication No. 2006-199264A

By the way, it is necessary to consider driving assistance corresponding to a scene in which a vehicle to be assisted in driving is a saddle-type vehicle such as a motorcycle and the vehicle passes through a gate built on a road.

For example, at the entrances or exits of toll roads, there are gates (tollbooths) for toll collection and so on. At the entrance or exit of a busy toll road like an expressway, the road widens, and a plurality of gates are arranged side by side in the width direction of the road. Before and after those gates, the number of lanes changes. On the upstream side of the gates, lanes branch, so the number of lanes increases, and on the downstream side of the gates, the lanes join, so the number of lanes decreases. If a plurality of vehicles pass through a plurality of gates, respectively, at the same time, those vehicles may suddenly approach or come into contact with each other at the lane merge place on the downstream side of the gates. For this reason, in a scene in which a vehicle passes through a gate of a toll road, it is required to assist in driving the vehicle in order to avoid sudden approaching or contact between the vehicle and any other vehicle at a lane merge place on the downstream side of the gate.

Also, in general, saddle-type vehicles such as motorcycles have higher acceleration performance as compared to other automobiles having four or more wheels, and can turn in a small radius. Therefore, in the case where the vehicle is a saddle-type vehicle and another vehicle is an automobile having four or more wheels, after the vehicle and the other vehicle pass through two gates, respectively, at the same time, if the vehicle is controlled such that the vehicle arrives at the lane merge place earlier than the other vehicle, it is possible to smoothly avoid sudden approaching or contact between the vehicle and the other vehicle. On the occasion of performing driving assistance for avoiding sudden approaching or contact between the vehicle and any other vehicle at the lane merge place, it is necessary to consider the performance of the saddle-type vehicle.

### SUMMARY

It is therefore one of objects of the present disclosure to provide a driving assistance device capable of improving the active safety performance of a saddle-type vehicle when the saddle-type vehicle passes through a gate built on a road.

According to an aspect of the embodiments of the present disclosure, there is provided a driving assistance device for assisting in driving a saddle-type vehicle, comprising: a first gate passage recognizing unit configured to recognize that a subject vehicle which is the saddle-type vehicle equipped with the driving assistance device has passed through a gate built on a road; a lateral-vehicle recognizing unit configured to recognize a lateral vehicle traveling side by side with the subject vehicle; and an acceleration assistance unit configured to perform assistance in accelerating the subject vehicle, if the lateral vehicle is recognized at a time when the vehicle has passed through the gate, on the basis of recognition of the first gate passage recognizing unit and recognition of the lateral-vehicle recognizing unit.

According to the present disclosure, it is possible to improve the active safety performance of a saddle-type vehicle when the saddle-type vehicle passes through a gate built on a road.

### BRIEF DESCRIPTION OF THE DRAWINGS

In the accompanying drawings:

FIG. 1 is an explanatory view illustrating an example of a scene in which a driving assistance device of an example of the present disclosure assists in driving a vehicle equipped with the driving assistance device;

FIG. 2 is an explanatory view illustrating the vehicle which is in the middle of passing through a gate, and another vehicle following the vehicle;

FIG. 3 is an explanatory view illustrating a situation where the vehicle and another vehicle passed through two gates built at an entrance of a toll road, almost at the same time, and immediately after the passage, the other vehicle is traveling side by side with the vehicle;

FIG. 4 is a block diagram illustrating the configuration of the driving assistance device of the example of the present disclosure; and

FIG. 5 is a flow chart illustrating a driving assistance process which is performed by the driving assistance device of the example of the present disclosure.

### DETAILED DESCRIPTION OF THE EMBODIMENTS

A driving assistance device of an embodiment of the present disclosure is a device for assisting in driving a saddle-type vehicle, and includes a gate passage recognizing unit (a first gate passage recognizing unit), a lateral-vehicle recognizing unit, and an acceleration assistance unit. The gate passage recognizing unit recognizes that a subject vehicle which is the saddle-type vehicle equipped with the driving assistance device has passed through a gate built at an entrance, an exit, or the like of a road, for example, by cameras and so on installed in the subject vehicle. The lateral-vehicle recognizing unit recognizes lateral vehicles traveling side by side with the subject vehicle, for example, by the cameras and so on installed in the vehicle. The acceleration assistance unit performs assistance in accelerating the subject vehicle if a lateral vehicle is recognized at a time when the subject vehicle has passed through the gate, on the basis of recognition of the gate passage recognizing unit and recognition of the lateral-vehicle recognizing unit. The assistance in accelerating may be a control for making the ratio of acceleration of the subject vehicle with respect to the driver's operation on the accelerator of the subject vehicle, higher than usual, or may be a control for automatically accelerating the subject vehicle.

In the driving assistance device of the embodiment of the present disclosure, when the vehicle and another vehicle have passed through two gates, built side by side in the width direction of a road at an entrance, an exit, or the like of the road, respectively, at the same time, the gate passage recognizing unit recognizes that the subject vehicle has passed through the gate, and the lateral-vehicle recognizing unit recognizes the other vehicle (the lateral vehicle) traveling side by side with the subject vehicle. Then, on the basis of the recognition of them, the acceleration assistance unit performs assistance in accelerating the subject vehicle. As a result, the subject vehicle arrives at a lane merge place on the downstream side of the gates, earlier than the lateral vehicle. Therefore, it is possible to avoid sudden approaching or contact between the subject vehicle and the lateral vehicle at the lane merge place on the downstream side of the gates. Like this, according to the driving assistance device of the embodiment of the present disclosure, it is possible to improve the active safety performance of the saddle-type vehicle when the saddle-type vehicle passes through a gate built on a road.

Also, the driving assistance device of the embodiment of the present disclosure accelerates the subject vehicle which is a saddle-type vehicle equipped with the driving assistance device such that the subject vehicle arrives at the lane merge place earlier than the lateral vehicle, thereby avoiding sudden approaching or contact between the subject vehicle and the lateral vehicle. Therefore, as compared to the case of decelerating the subject vehicle such that the subject vehicle arrives at the lane merge place later than the lateral vehicle in order to avoid sudden approaching or contact between the subject vehicle and the lateral vehicle, it is possible to more smoothly avoid sudden approaching or contact between the subject vehicle and the lateral vehicle. In other words, since saddle-type vehicles have higher acceleration performance as compared to other types of vehicles, and can turn in a small radius, if the subject vehicle which is a saddle-type vehicle is controlled such that the vehicle travels ahead of the lateral vehicle which is another type of vehicle, it is possible to more quickly and easily avoid sudden approaching or contact between both vehicles, and the stress of the driver of the subject vehicle becomes less.

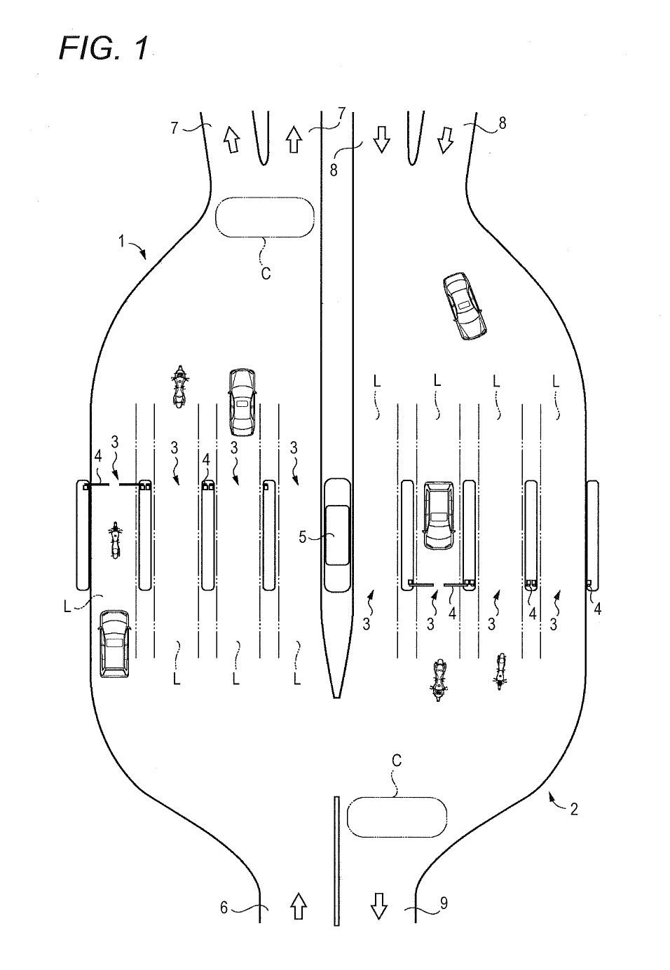

FIG. 1 shows an example of a scene in which a driving assistance device of an example of the present disclosure performs assistance in driving a vehicle equipped with the driving assistance device. As shown in FIG. 1, in a scene in which the vehicle (the vehicle to be assisted in driving by the driving assistance device) passes through a gate 3 built at an entrance 1 or an exit 2 of a toll road, the driving assistance device of the example of the present disclosure can perform assistance in driving the vehicle.

In general, at the entrances or exits of toll roads, there are gates for collecting tolls for the toll roads. In the gates, there are manned gates and unmanned gates. Nowadays, ETC (Electronic Toll Collection) gates which are unmanned gates have been spread. Also, for example, like expressways, in the case of toll roads each of which has a plurality of entrances and exits between the start point and end point of the toll road and has sections for which different tolls have been set, in general, at all of the entrances and exists of each toll road, there are gates. Also, for example, like toll tunnels, in the case of toll roads each of which has an entrance and an exit only at the start point and end point of the toll road and for which a toll has been set regardless of sections, some toll roads each have gates only on one side of the entrance and the exit. Also, for example, like expressways, in the case of toll roads which a lot of vehicles use, many toll roads each have a plurality of gates at each entrance or exit. In this case, at each entrance or exit, the road widens, and there is a plurality of gates arranged side by side in the width direction of the road. Also, in the case where the number of gates is larger than the number of lanes connected to an entrance or an exit, before and after the gates, the number of lanes changes. In other words, on the upstream side of the gates, the number of lanes increases, and on the downstream side of the gates, the number of lanes decreases.

In the example shown in FIG. 1, at the entrance 1 and the exit 2 of the toll road, the road widens, and at the entrance 1, there are four gates 3 arranged side by side in the width direction of the road, and at the exit 2, there are four gates 3 arranged side by side in the width direction of the road. Also, at the entrance 1 and the exit 2, there are lanes L corresponding to the gates 3, respectively. Also, in each of the entrance 1 and the exit 2, of the four gates 3, three gates 3 on the outer side of the road are ETC gates, and one gate 3 on the center side of the road is a manned gate. The gates 3 which are ETC gates are equipped with gate bars 4 and ETC communication devices (not shown in the drawings). Also, beside the manned gate 3, there is a working booth 5 where toll collectors work.

Also, the upstream side of the entrance 1 in the vehicle traveling direction (the lower side in FIG. 1) is connected to one road 6 having one lane, and the downstream side of the entrance 1 in the vehicle traveling direction (the upper side in FIG. 1) is connected to two roads 7 each of which has one lane. Therefore, at the entrance 1, on the upstream side of the gates 3, the number of lanes increases from one to four, and on the downstream side of the gates 3, the number of lanes substantively decreases from four to two. Also, the upstream side of the exit 2 in the vehicle traveling direction (the upper side in FIG. 1) is connected to two roads 8 each of which has one lane, and the downstream side of the exit 2 in the vehicle traveling direction (the lower side in FIG. 1) is connected to one road 9 having one lane. Therefore, at the exit 2, on the upstream side of the gates 3, the number of lanes substantively increases from two to four, and on the downstream side of the gates 3, the number of lanes decreases from four to one. Also, at each of the entrance 1 and the exit 2, on the downstream side of the gates 3, there is a lane merge place C where the four lanes L join.

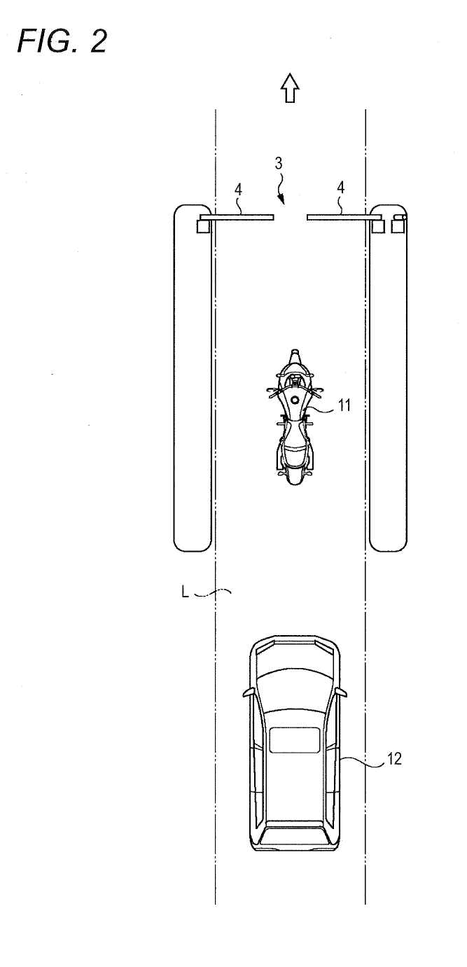

FIG. 2 shows a vehicle 11 which is equipped with a driving assistance device and is in the middle of passing through a gate 3, and another vehicle 12 following the vehicle. The vehicle which is the object of driving assistance of a driving assistance device 21 of the example of the present disclosure is, for example, a saddle-type vehicle such as a motorcycle. Also, as shown in FIG. 2, the driving assistance device 21 has a function of issuing a warning to another vehicle (a following vehicle 12) traveling directly behind the vehicle 11 which is a saddle-type vehicle if the following vehicle 12 approaches the vehicle 11 until the distance between the vehicle 11 and the following vehicle 12 becomes shorter than a predetermined distance when the vehicle 11 is in the middle of passing through the gate 3 (a first driving assistance function). However, the following vehicle 12 is not limited to a four-wheeled automobile as shown in FIG. 2, and may be a saddle-type vehicle, or may be a vehicle having more than four wheels, like a large-sized truck. Also, the following vehicle 12 may be a manual vehicle, or may be a self-driving vehicle (a vehicle having one or more autonomous driving levels).

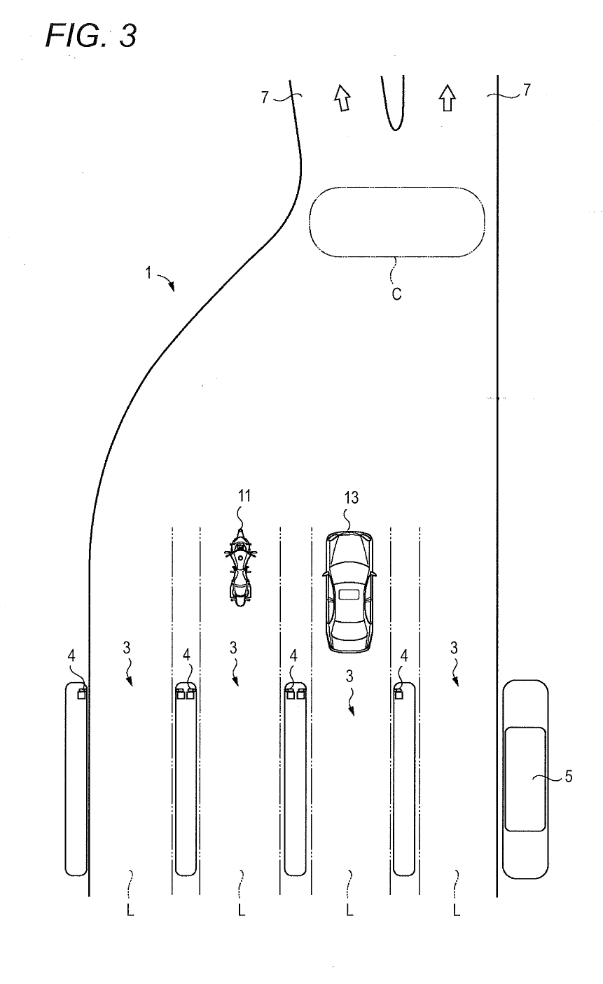

FIG. 3 shows a situation in which the vehicle 11 and another vehicle passed through, for example, two gates 3 built at the Entrance 1, almost at the same time, and immediately after the passage, the other vehicle is traveling side by side with the vehicle 11. The driving assistance device 21 of the example of the present disclosure has a function of performing assistance in accelerating the vehicle 11 if any other vehicle (a lateral vehicle 13) is traveling side by side with the vehicle 11 which is a saddle-type vehicle and the lateral vehicle 13 is an automobile having four or more wheels as shown in FIG. 3 after the vehicle 11 passes through a gate 3 (a second driving assistance function). In automobiles having four or more wheels, four-wheeled automobiles, and vehicles having more than four wheels, such as large-sized trucks, are included. Also, a lateral vehicle may be a manual vehicle, or may be a self-driving vehicle.

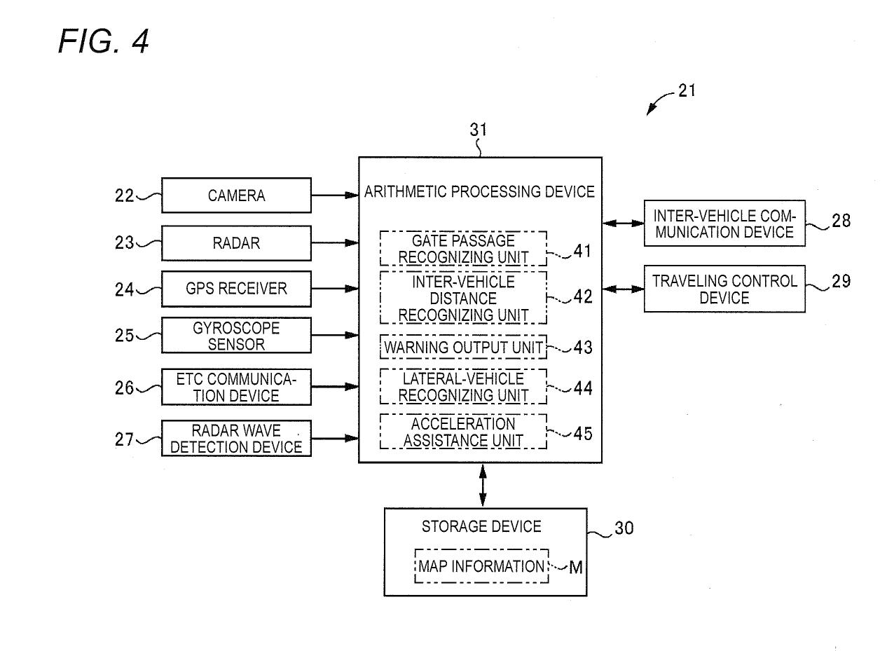

FIG. 4 shows the configuration of the driving assistance device 21 of the example of the present disclosure. As shown in FIG. 4, the driving assistance device 21 includes a plurality of cameras 22, a plurality of radars 23, a GPS (Global Positioning System) receiver 24, a gyroscope sensor 25, an ETC communication device 26, a radar wave detection device 27, an inter-vehicle communication device 28, a traveling control device 29, a storage device 30, an arithmetic processing device 31, and so on. All of these components of the driving assistance device 21 are installed in the vehicle 11.

The plurality of cameras 22 is, for example, video cameras, and is installed in the vehicle 11 so as to be able to image the area in front of the vehicle 11, the area behind the vehicle, the area on the left side of the vehicle, and the area on the right side of the vehicle. However, the cameras 22 may be still cameras. Also, besides the cameras 22 using visible light, infrared cameras may be installed. The radars 23 are, for example, millimeter-wave radars or laser radars. Both types of radars may be installed. Also, the plurality of radars 23 is installed in the vehicle 11 so as to be able to detect objects existing in front of, behind, on the left side, and on the right side of the vehicle. However, besides the cameras 22 and the radars 23, ultrasonic sensors may be installed.

The GPS receiver 24 is a device for receiving signals which are transmitted from GPS satellites, and is used to recognize the location of the vehicle by a GPS. The gyroscope sensor 25 is used to correct an error having occurred in recognizing the location of the vehicle 11 by the GPS, or to recognize the location of the vehicle 11 when it is impossible to receive signals which are transmitted from GPS satellites by the GPS receiver 24. The ETC communication device 26 is a device for performing communication with ETC communication devices installed at ETC gates. The radar wave detection device 27 is a device for detecting radar waves which are emitted from other vehicles toward the vehicle 11.

The inter-vehicle communication device 28 is a device for performing communication between the vehicle 11 and other vehicles. The traveling control device 29 is a device for controlling traveling of the vehicle 11. The traveling control device 29 can control the degree of opening (the degree of throttle opening) of a throttle valve installed in the vicinity of the intake port of the engine of the vehicle 11, or the fuel injection quantity of the fuel injection device installed in the vicinity of the intake port of the engine so as to inject fuel to be fed into the combustion chamber of the engine.

The storage device 30 has, for example, semiconductor memory elements. In the storage device 30, map information M is stored in advance. The map information M is used to recognize the location of the vehicle 11 by the gyroscope sensor 25.

The arithmetic processing device 31 includes, for example, a CPU (Central Processing Unit). The arithmetic processing device 31 acts as a gate passage recognizing unit 41, an inter-vehicle distance recognizing unit 42, a warning output unit 43, a lateral-vehicle recognizing unit 44, and an acceleration assistance unit 45 by reading out a program from the storage device 30 or the like and executing the program. The gate passage recognizing unit 41 has a function of recognizing that the vehicle 11 is in the middle of passing through a gate 3. Also, the gate passage recognizing unit 41 has a function of recognizing that the vehicle 11 has passed through a gate 3. The inter-vehicle distance recognizing unit 42 has a function of recognizing that the distance between the vehicle 11 and a following vehicle 12 has become shorter than the predetermined distance. The warning output unit 43 has a function of issuing a warning to a following vehicle 12, using inter-vehicle communication between the vehicle 11 and the following vehicle 12, if the distance between the vehicle 11 and the following vehicle 12 becomes shorter than the predetermined distance, when the vehicle 11 is in the middle of passing through a gate 3. The lateral-vehicle recognizing unit 44 has a function of recognizing presence of a lateral vehicle 13 and recognizing that the lateral vehicle 13 is an automobile having four or more wheels. The acceleration assistance unit 45 has a function of performing assistance in accelerating the vehicle 11 if a lateral vehicle 13 is recognized when the vehicle 11 has just passed through the gate 3.

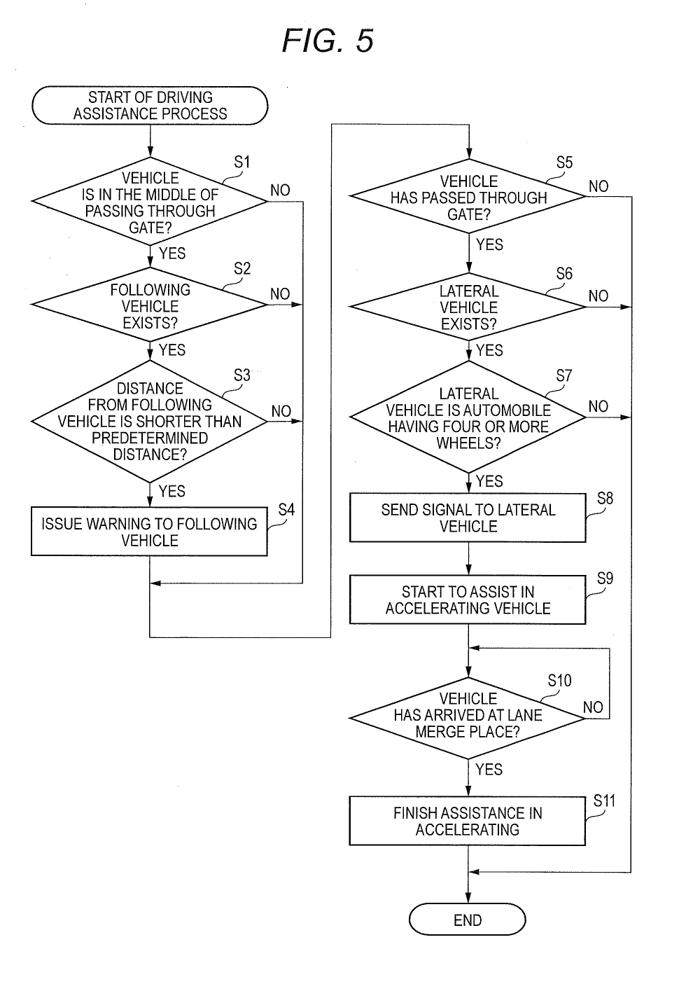

FIG. 5 shows a driving assistance process which is performed by the driving assistance device 21. The driving assistance process is repeatedly performed while the engine of the vehicle 11 is operating. Also, in the driving assistance process shown in FIG. 5, STEP S1 to STEP S4 are processing for realizing the first driving assistance function mentioned in the above description, and STEP S5 to STEP S11 are processing for realizing the second driving assistance function mentioned in the above description.

In the driving assistance process, first, the gate passage recognizing unit 41 of the driving assistance device 21 recognizes whether the vehicle 11 is in the middle of passing through the gate 3, using the GPS receiver 24, the gyroscope sensor 25, the map information M, the cameras 22, the ETC communication device 26, and so on (STEP S1). For example, the gate passage recognizing unit 41 recognizes the current location of the vehicle 11 on the basis of signals transmitted from GPS satellites and received by the GPS receiver 24, and corrects an error having occurred in the recognition, on the basis of a detection signal output from the gyroscope sensor 25 and the map information M, thereby recognizing the exact location of the vehicle 11. Further, the gate passage recognizing unit 41 performs image recognition using images acquired by imaging the area around the vehicle 11 by the cameras 22, thereby recognizing that the place where the vehicle 11 is traveling is in a gate 3. Furthermore, the gate passage recognizing unit 41 recognizes that the vehicle 11 has passed through the gate 3, on the basis of the fact that the ETC communication device 26 installed in the vehicle 11 has performed communication with the ETC communication device installed at the gate 3.

If the gate passage recognizing unit 41 recognizes that the vehicle 11 is in the middle of passing through a gate 3 (“YES” in STEP S1), subsequently, the inter-vehicle distance recognizing unit 42 recognizes whether there is any following vehicle 12, using the cameras 22 and the radars 23 (STEP S2). For example, the inter-vehicle distance recognizing unit 42 recognizes presence of a following vehicle 12 by performing image recognition using images acquired by imaging the area behind the vehicle 11 by a camera 22. Also, the inter-vehicle distance recognizing unit 42 recognizes presence of a following vehicle 12, on the basis of the reflected wave of a radar wave emitted from a radar 23 to the area behind the vehicle 11, and the like. Also, presence of a following vehicle 12 may be recognized by detecting a radar wave emitted from the following vehicle 12 by the radar wave detection device 27.

If presence of a following vehicle 12 is recognized by the inter-vehicle distance recognizing unit 42 (“YES” in STEP S2), subsequently, the inter-vehicle distance recognizing unit 42 recognizes whether the distance between the vehicle 11 and the following vehicle 12 is shorter than the predetermined distance, using the camera 22 and the radar 23 (STEP S3). For example, the inter-vehicle distance recognizing unit 42 recognizes that the distance between the vehicle 11 and the following vehicle 12 is shorter than the predetermined distance, on the basis of the ratios of the images of the following vehicle 12 in images of the area behind the vehicle 11. Also, the inter-vehicle distance recognizing unit 42 recognizes that the distance between the vehicle 11 and the following vehicle 12 is shorter than the predetermined distance, by measuring the time from when the radar wave was emitted from the radar 23 to the area behind the vehicle 11 to when the reflected wave of the radar wave is received, and the frequency of the reflected wave. However, the “predetermined distance” which is used in recognizing whether the distance between the vehicle 11 and the following vehicle 12 is shorter than the predetermined distance can be determined, for example, as follows. In Japan, as the velocity in ETC gates, 20 km/h or less is common. In the case of considering the relative velocity between the vehicle 11 and the following vehicle 12 on the assumption of such low velocity, as the predetermined distance, for example, about 3 m to 5 m are appropriate values. Needless to say, in determining such a value, it is required to consider the laws, transportation condition, and so on of each country, and the above-mentioned values are merely examples of values determined on the assumption that vehicles travel on a road in Japan.

If the inter-vehicle distance recognizing unit 42 recognizes that the distance between the vehicle 11 and the following vehicle 12 is shorter than the predetermined distance (“YES” in STEP S3), subsequently, the warning output unit 43 issues a warning to the following vehicle 12 (STEP S4). Specifically, the warning output unit 43 controls the inter-vehicle communication device 28 such that the inter-vehicle communication device transmits a warning from the vehicle 11 to the following vehicle 12. As the warning, hazard ramps mounted on the vehicle 11 may be flashed.

For example, when the vehicle 11 is in the middle of passing through the gate as shown in FIG. 2, if the following vehicle 12 approaches the rear part of the vehicle 11, the approach of the following vehicle is recognized in the vehicle 11, and a warning is issued from the vehicle 11 to the following vehicle 12. Therefore, in the case where the following vehicle 12 is a manual vehicle, on the basis of the warning, the driver of the following vehicle 12 can recognize that the vehicle which the driver is driving is approaching the vehicle ahead, and can surely decelerate the vehicle which the driver is driving. Also, in the case where the following vehicle 12 is a self-driving vehicle, on the basis of the warning, the following vehicle 12 can surely decelerate such that the corresponding vehicle does not suddenly approach or come into contact with the vehicle ahead. Therefore, when the vehicle 11 is passing through the gate 3, the following vehicle 12 is prevented from suddenly approaching or coming into contact with the vehicle 11. Meanwhile, if it is not recognized by the gate passage recognizing unit 41 that the vehicle 11 is in the middle of passing through the gate 3 (“NO” in STEP S1), or if where presence of a following vehicle 12 is not recognized by the inter-vehicle distance recognizing unit 42 (“NO” in STEP S2), or if it is not recognized by the inter-vehicle distance recognizing unit 42 that the distance between the vehicle 11 and a following vehicle 12 is shorter than the predetermined distance (“NO” in STEP S3), as shown in FIG. 5, the process proceeds from STEP S1, S2, or S3 directly to STEP S5.

Subsequently, the gate passage recognizing unit 41 recognizes whether the vehicle 11 has passed through the gate 3, using the GPS receiver 24, the gyroscope sensor 25, the map information M, the cameras 22, the ETC communication device 26, and so on (STEP S5). This recognition can be performed by the same method as the recognition method performed in STEP S1. Also, in STEP S5, for example, it is desirable to recognize that the vehicle 11 has passed through the gate 3 when it is recognized that the whole of the vehicle 11 has got out of the gate 3, or when it is recognized that the vehicle 11 has passed the gate bar 4.

If it is recognized by the gate passage recognizing unit 41 that the vehicle 11 has passed through the gate 3 (“YES” in STEP S5), subsequently, the lateral-vehicle recognizing unit 44 recognizes whether there is any lateral vehicle 13, using the cameras 22, the radars 23, and so on (STEP S6). For example, the lateral-vehicle recognizing unit 44 recognizes presence of lateral vehicles 13 by performing image recognition using images acquired by imaging the areas on both sides of the vehicle 11 by the cameras 22. Also, the lateral-vehicle recognizing unit 44 recognizes presence of lateral vehicles 13 on the basis of the reflected waves of radar waves emitted from the radars 23 to the areas on both sides of the vehicle 11.

If presence of a lateral vehicle 13 is recognized by the lateral-vehicle recognizing unit 44 (“YES” in STEP S6), subsequently, the lateral-vehicle recognizing unit 44 recognizes whether the lateral vehicle 13 is an automobile having four or more wheels, on the basis of images of the lateral vehicle 13 included in images acquired by imaging the area on the side of the vehicle 11 by a camera 22 (STEP S7).

If it is recognized by the lateral-vehicle recognizing unit 44 that the lateral vehicle 13 is an automobile having four or more wheels (“YES” in STEP S7), subsequently, the acceleration assistance unit 45 sends a signal toward the lateral vehicle 13 (STEP S8). For example, the acceleration assistance unit 45 flickers a direction indicator ramp positioned on the side where the lateral vehicle 13 is present as seen from the vehicle 11, as a signal. Also, a signal may be transmitted to the lateral vehicle 13 by the inter-vehicle communication device 28.

Subsequently, the acceleration assistance unit 45 starts to assist in accelerating the vehicle 11 (STEP S9). For example, the acceleration assistance unit 45 controls the traveling control device 29 such that the traveling control device makes the ratio of the degree of throttle opening or the increase in the fuel injection quantity to the increase in the driver's operation on the accelerator of the vehicle 11, higher than usual, such that the vehicle 11 gets ready to become faster than usual, in response to the driver's operation on the accelerator of the vehicle 11. Therefore, the driver of the vehicle 11 can easily drive the vehicle 11 ahead of the lateral vehicle 13 by accelerating the vehicle 11. As a result, the vehicle 11 arrives at the lane merge place C (see FIG. 3) earlier than the lateral vehicle 13.

Subsequently, the acceleration assistance unit 45 determines whether the vehicle has arrived at the lane merge place C (STEP S10). For example, the acceleration assistance unit 45 recognizes the distance from the location when the vehicle 11 has just passed through the gate 3 to the lane merge place C, on the basis of an image acquired by imaging the area in front of the vehicle 11 by a camera 22 and the map information M, and calculates the movement time required to travel from the location when the vehicle 11 has just passed through the gate 3 to the lane merge place C, on the basis of the corresponding distance and the velocity of the vehicle 11, and determines that the vehicle 11 has arrived at the lane merge place C, if the corresponding movement time elapses from when the vehicle 11 has just passed through the gate 3. However, with respect to each of the entrances and exits of toll roads around the country, data on the distances from the locations when vehicles have just passed through gates to a lane merge place, or the times required to move the corresponding distances may be stored in the storage device 30 in advance, and such data may be used to determine whether the vehicle 11 has arrived at the lane merge place.

If the acceleration assistance unit 45 determines that the vehicle 11 has arrived at the lane merge place C, the acceleration assistance unit 45 finishes the acceleration assistance (STEP S11).

Meanwhile, if it is not recognized by the gate passage recognizing unit 41 that the vehicle 11 has passed through the gate 3 (“NO” in STEP S5), or if presence of any lateral vehicle 13 is not recognized by the lateral-vehicle recognizing unit 44 (“NO” in STEP S6), or if it is not recognized by the lateral-vehicle recognizing unit 44 that a lateral vehicle 13 is an automobile having four or more wheels (“NO” in STEP S7), as shown in FIG. 5, immediately after the process of STEP S5, S6, or S7 is performed, the driving assistance process is finished.

For example, as shown in FIG. 3, when the vehicle 11 has passed through the gate 3, if there is an automobile having four or more wheels (a lateral vehicle 13) traveling side by side with the vehicle 11, presence of the lateral vehicle is recognized in the vehicle 11, and assistance in accelerating the vehicle 11 is started. According to the start of acceleration assistance, the vehicle 11 gets ready to become faster than usual, in response to the operation on the accelerator. Therefore, the driver of the vehicle 11 can easily accelerate the vehicle 11 by operating the accelerator, so it is possible to easily drive the vehicle 11 ahead of the lateral vehicle 13. Therefore, the driver of the vehicle 11 can easily drive the vehicle 11 such that the vehicle arrives at the lane merge place C earlier than the lateral vehicle 13. As a result, it is possible to prevent the vehicle 11 and the lateral vehicle 13 from suddenly approaching or coming into contact with each other at the lane merge place C.

As described above, according to the driving assistance device 21 of the example of the present disclosure, when the vehicle 11 is in the middle of passing through a gate 3, if the distance between the vehicle 11 and a following vehicle 12 becomes shorter than the predetermined distance, the driving assistance device issues a warning to the following vehicle 12. Therefore, it is possible to prevent the lateral vehicle 13 from suddenly approaching or coming into contact with the vehicle 11 at the gate 3. In other words, in the case where a gate built at an entrance or an exist of a toll road is an ETC gate, each vehicle decelerates on the upstream side of the gate. Also, in the case where a gate is a manned gate, each vehicle temporarily stops at the gate. In both cases, when the vehicle equipped with the driving assistance device passes through the gate, the vehicle decelerates on the upstream side of the gate. Therefore, if the following vehicle recognizes the deceleration of the vehicle ahead (i.e. the vehicle equipped with the driving assistance device) late or fails in recognizing, the following vehicle may suddenly approach or come into contact with the rear part of the vehicle. Particularly, saddle-type vehicles have bodies smaller than those of four-wheeled automobiles. For this reason, not only in automatic recognition using acquired images and the radars but also in driver's visual recognition, saddle-type vehicles are likely to be recognized late, or are likely to be missed. According to the driving assistance device 21 of the example of the present disclosure, if the following vehicle 12 approaches the vehicle 11 until the distance between the vehicle 11 and the following vehicle 12 becomes shorter than the predetermined distance, the driving assistance device issues a warning to the following vehicle 12. Therefore, even in the case where the following vehicle 12 recognizes deceleration of the vehicle ahead (i.e. the vehicle 11) late, or fails in recognizing, it is possible to make the following vehicle 12 or the driver of the following vehicle recognize that the vehicle 11 and the following vehicle 12 are getting closer to each other. Therefore, it is possible to prevent the following vehicle 12 from suddenly approaching or coming into contact with the vehicle 11 at the gate 3.

Also, by transmitting a warning to the following vehicle 12 using inter-vehicle communication between the vehicle 11 and the following vehicle 12, it is possible to surely give the warning to the following vehicle 12. Especially, in the case where the following vehicle 12 is a self-driving vehicle, it is possible to quickly make the following vehicle 12 recognize that the following vehicle is approaching the vehicle ahead, using inter-vehicle communication.

Also, according to the driving assistance device 21 of the example of the present disclosure, when the vehicle 11 has passed through the gate 3, if a lateral vehicle 13 is recognized, the driving assistance device performs assistance in accelerating the vehicle 11 such that the vehicle 11 can easily arrive at the lane merge place C earlier than the lateral vehicle 13. Therefore, it is possible to avoid sudden approaching or contact between the vehicle 11 and the lateral vehicle 13 at the lane merge place C.

Also, since saddle-type vehicles have higher acceleration performance as compared to automobiles having four or more wheels, and can turn in a small radius, in the case of assisting in driving the vehicle 11 which is a saddle-type vehicle such that the vehicle runs ahead of the lateral vehicle 13, it is possible to more quickly and easily avoid sudden approaching or contact between both vehicles, and the stress of the driver of the vehicle is less. The driving assistance device 21 of the embodiment of the present disclosure accelerates the vehicle 11 which is a saddle-type vehicle such that the vehicle 11 arrives at the lane merge place C earlier than the lateral vehicle 13 in order to avoid sudden approaching or contact between the vehicle 11 and the lateral vehicle 13. Therefore, as compared to the case of decelerating the vehicle 11 such that the vehicle 11 arrives at the lane merge place C later than the lateral vehicle 13 in order to avoid sudden approaching or contact between the vehicle 11 and the lateral vehicle 13, it is possible to more smoothly avoid sudden approaching or contact between the vehicle 11 and the lateral vehicle 13.

Also, according to the driving assistance device 21 of the example of the present disclosure, the driving assistance device recognizes whether the lateral vehicle 13 is an automobile having four or more wheels, and if the lateral vehicle 13 is an automobile having four or more wheels, the driving assistance device performs assistance in accelerating the vehicle 11. Therefore, it is possible to surely perform smooth avoidance of sudden approaching or contact between the vehicle 11 and the lateral vehicle 13 at the lane merge place C. By the way, in the case where both of the vehicle 11 and the lateral vehicle 13 are saddle-type vehicles, since it is hard to determine which of both vehicles is better in acceleration performance, even though the vehicle 11 is accelerated such that the vehicle arrives at the lane merge place C earlier, it may not be possible to smoothly avoid sudden approaching or contact between both vehicles. For this reason, it is considered that in the case where both of the vehicle 11 and the lateral vehicle 13 are saddle-type vehicles, it would be better that the driver of the vehicle 11 judges the specific situation in that place (for example, the displacement difference between the vehicle 11 and the lateral vehicle 13), and determines whether to go ahead of the lateral vehicle 13 or go behind the lateral vehicle, and manually controls the velocity of the vehicle 11 such that it is possible to smoothly avoid sudden approaching or contact between both vehicles. According to the driving assistance device of the example of the present disclosure, if the lateral vehicle 13 is an automobile having four or more wheels, the driving assistance device performs assistance in accelerating the vehicle 11; whereas if the lateral vehicle 13 is, for example, a saddle-type vehicle, the driving assistance device does not perform assistance in accelerating the vehicle 11. Therefore, it is possible to surely perform smooth avoidance of sudden approaching or contact between the vehicle 11 and the lateral vehicle 13 at the lane merge place C.

Also, the driving assistance device 21 of the example of the present disclosure performs assistance in accelerating the vehicle 11 in the section from the location when the vehicle 11 has just passed through the gate 3 to the lane merge place C. Therefore, it is possible to surely make the vehicle 11 arrive at the lane merge place C earlier than the lateral vehicle 13. Also, after the vehicle 11 passes through the lane merge place C earlier than the lateral vehicle 13, it is possible to prevent assistance in accelerating from continuing, thereby preventing the vehicle 11 from excessively accelerating against the driver's intention.

Also, since the driving assistance device performs assistance in accelerating the vehicle 11 by controlling the degree of throttle opening or the fuel injection quantity in the vehicle 11, the driver of the vehicle 11 can easily accelerate the vehicle 11 and can easily drive the vehicle 11 ahead of the lateral vehicle 13, by opening the accelerator.

In the above-described example, the case where the vehicle 11 is a saddle-type vehicle having an engine as a power source for traveling, and the driving assistance device performs assistance in accelerating by controlling the degree of throttle opening or the fuel injection quantity such that the vehicle 11 gets ready to run faster than usual has been taken as an example. However, in the case where the vehicle 11 is a saddle-type motorized or hybrid vehicle having an electric motor as a power source for traveling, the driving assistance device may perform assistance in accelerating by controlling the rotation speed of the electric motor such that the vehicle 11 gets ready to run faster than usual. Specifically, the driving assistance device makes the ratio of the increase in the rotation speed of the electric motor to the increase in the driver's operation on the accelerator of the vehicle 11, higher than usual.

Also, in the above-described example, the case of performing assistance in accelerating until the vehicle 11 arrives at the lane merge place C has been taken as an example; however, instead of this, the driving assistance device may be configured to perform assistance in accelerating until the vehicle 11 arrives at a location in front of the lateral vehicle 13 and sufficiently apart from the lateral vehicle 13.

Also, in FIG. 2, FIG. 3, and so on of the above-described example, as an example of the saddle-type vehicle which is the vehicle 11, the motorcycle has been taken; however, the vehicle 11 may be any other type of saddle-type vehicle, such as a motor tricycle.

Also, in the above-described example, the case of performing assistance in driving the vehicle by the driving assistance device when the vehicle passes through a gate built at an entrance or exist of a toll road has been taken as an example; however, assistance in driving the vehicle may be performed by the driving assistance device when the vehicle passes through a gate built at an entrance, an exist, or a middle point of a road other than toll roads.

Also, the present invention can be appropriately modified without departing from the gist and idea of the invention which can be read from claims and the entire specification, and driving assistance devices according to those modifications are also included in the technical idea of the present invention.

What is claimed is:

1. A driving assistance device for assisting in driving a saddle-type vehicle, comprising:
a first gate passage recognizing unit configured to recognize that a subject vehicle which is the saddle-type vehicle equipped with the driving assistance device has passed through a gate built on a road;
a lateral-vehicle recognizing unit configured to recognize a lateral vehicle traveling side by side with the subject vehicle; and
an acceleration assistance unit configured to perform assistance in accelerating the subject vehicle, if the lateral vehicle is recognized at a time when the vehicle has passed through the gate, on the basis of recognition of the first gate passage recognizing unit and recognition of the lateral-vehicle recognizing unit.

2. The driving assistance device according to claim 1,
wherein the lateral-vehicle recognizing unit recognizes whether the lateral vehicle is an automobile having four or more wheels, and
wherein the acceleration assistance unit performs the assistance in accelerating the subject vehicle, if the recognized lateral vehicle is the automobile having four or more wheels on the basis of recognition of the lateral-vehicle recognizing unit.

3. The driving assistance device according to claim 1, wherein the acceleration assistance unit performs the assistance in accelerating the subject vehicle until the subject vehicle arrives at a place where a plurality of lanes corresponding to a plurality of gates built on the road join at a downstream side.

4. The driving assistance device according to claim 1, wherein the acceleration assistance unit performs the assistance in accelerating the subject vehicle by controlling a degree of throttle opening, a fuel injection quantity, or a rotation speed of an electric motor used as a power source for traveling, in the subject vehicle.

5. The driving assistance device according to claim 1, further comprising:
a second gate passage recognizing unit configured to recognize that the subject vehicle is in the middle of passing through the gate;
an inter-vehicle distance recognizing unit configured to recognize whether a distance between the subject vehicle and a following vehicle traveling directly behind the subject vehicle is shorter than a predetermined distance; and
a warning output unit configured to issue a warning to the following vehicle, if the distance between the subject vehicle and the following vehicle becomes shorter than the predetermined distance at a time when the vehicle is in the middle of passing through the gate, on the basis of recognition of the second gate passage recognizing unit and recognition of the inter-vehicle distance recognizing unit.

6. The driving assistance device according to claim 5, wherein the warning output unit transmits the warning to the following vehicle, using inter-vehicle communication between the subject vehicle and the following vehicle.

7. The driving assistance device according to claim 2, wherein the acceleration assistance unit performs the assistance in accelerating the subject vehicle until the subject vehicle arrives at a place where a plurality of lanes corresponding to a plurality of gates built on the road join at a downstream side.

8. The driving assistance device according to claim 2, wherein the acceleration assistance unit performs the assistance in accelerating the subject vehicle by controlling a degree of throttle opening, a fuel injection quantity, or a rotation speed of an electric motor used as a power source for traveling, in the subject vehicle.

9. The driving assistance device according to claim 3, wherein the acceleration assistance unit performs the assistance in accelerating the subject vehicle by controlling a degree of throttle opening, a fuel injection quantity, or a rotation speed of an electric motor used as a power source for traveling, in the subject vehicle.

10. The driving assistance device according to claim 2, further comprising:
a second gate passage recognizing unit configured to recognize that the subject vehicle is in the middle of passing through the gate;
an inter-vehicle distance recognizing unit configured to recognize whether a distance between the subject vehicle and a following vehicle traveling directly behind the subject vehicle is shorter than a predetermined distance; and
a warning output unit configured to issue a warning to the following vehicle, if the distance between the subject vehicle and the following vehicle becomes shorter than the predetermined distance at a time when the vehicle is in the middle of passing through the gate, on the basis of recognition of the second gate passage recognizing unit and recognition of the inter-vehicle distance recognizing unit.

11. The driving assistance device according to claim 3, further comprising:
a second gate passage recognizing unit configured to recognize that the subject vehicle is in the middle of passing through the gate;
an inter-vehicle distance recognizing unit configured to recognize whether a distance between the subject vehicle and a following vehicle traveling directly behind the subject vehicle is shorter than a predetermined distance; and
a warning output unit configured to issue a warning to the following vehicle, if the distance between the subject vehicle and the following vehicle becomes shorter than the predetermined distance at a time when the vehicle is in the middle of passing through the gate, on the basis of recognition of the second gate passage recognizing unit and recognition of the inter-vehicle distance recognizing unit.

12. The driving assistance device according to claim 4, further comprising:
a second gate passage recognizing unit configured to recognize that the subject vehicle is in the middle of passing through the gate;
an inter-vehicle distance recognizing unit configured to recognize whether a distance between the subject vehicle and a following vehicle traveling directly behind the subject vehicle is shorter than a predetermined distance; and
a warning output unit configured to issue a warning to the following vehicle, if the distance between the subject vehicle and the following vehicle becomes shorter than the predetermined distance at a time when the vehicle is in the middle of passing through the gate, on the basis of recognition of the second gate passage recognizing unit and recognition of the inter-vehicle distance recognizing unit.
